(19) United States
(12) Patent Application Publication
(10) Pub. No.: US 2017/0243439 A1
(43) Pub. Date: Aug. 24, 2017

(54) Informational Game System

(71) Applicant: Marlon Moodie, Stamford, CT (US)

(72) Inventor: Marlon Moodie, Stamford, CT (US)

(21) Appl. No.: 15/168,894

(22) Filed: May 31, 2016

Related U.S. Application Data
(60) Provisional application No. 62/299,351, filed on Feb. 24, 2016.

(51) Int. Cl. G07F 17/32

(52) U.S. Cl. CPC G07F 17/3244

(57) ABSTRACT

An app for a mobile device wherein a player may join a game for a fee and all players in the current game are simultaneously presented with a series of questions in a first round where each question must be answered within a specified time frame. The players are scored based on the number of correct answers submitted and the time taken to submit those answers. The winners of the first round are further simultaneously provided with a final round question where the final winner is determined by who answered the final question correctly in the shorted time. Winnings for the game are then transferred to the final winner's account.

### FIELD OF THE INVENTION

The invention relates to a the field of game apps that can be downloaded onto a smartphone, and more particularly to a game app that allows a user to purchase the opportunity to answer a series of questions within a limited amount of time where if the member answers the questions correctly and faster than the other players in the game, they receive a cash prize.

### BACKGROUND OF THE INVENTION

The field of game applications (apps) for download onto smartphone devices has exploded in the past ten years. With the increase in mobile device coverage, the increase in mobile bandwidth, and the increased computing power of hand held mobile devices, the demand for apps has increased markedly.

Game apps that allow for cash prizes have been around for some time. In particular, game apps that are games of chance will often come under the gaming regulations that regulate gambling. However, other game apps are not games of chance, but rather, are games of skill.

Known Apps that are games of skill include, for example, Dollar Candy is a game that lets a player make money by competing in sixty second games of skill by matching tiles. The more tiles that are matched correctly in a row, the more points the player receives. Likewise, the quicker the player matches tiles and completes the board, the more points they receive. However, Dollar Candy is a tile matching game that is directed toward visual mapping. Likewise, Dollar Candy is a game where the entire board is shown to the person for a period of 60 seconds rather than being structured as a sequential game with limited time frames for answering each question. Likewise, there are not tiers in the game where the top players from the first tier are selected to move to a subsequent tier to simultaneously compete against each other in the second tier.

Another know App is Skillz, which includes a tournament management system that can be integrated into a mobile game to offer eSports competitions to players. So for example, eSports could include a bowling tournament where players post real money and play against other players that also post their money where the winner receives the proceeds. Skillz is primarily directed toward the visual interface and tests hand eye coordination. Skillz is not directed toward answering questions in a sequential manner with a limited time frame for answering each question. Likewise, there are not tiers in the game where the top players from the first tier are selected to move to a subsequent tier to simultaneously compete against each other in the second tier.

Still another online gaming system is disclosed in U.S. Pat. No. 7,470,197 (the '197 patent) entitled “On-line gaming with independent player matching” that matches a person up with a competitor and the prize fund is generated from their entry fee. Each round opponents are selected at random where any players that loses a round is eliminated from the current game. However, the '197 patent matches two players against each other such that one is eliminated each round. The '197 patent is not directed toward answering questions in a sequential manner with a limited time frame for answering each question. Likewise, there are not tiers in the game where the top players from the first tier are selected to move to a subsequent tier to simultaneously compete against each other in the second tier.

### SUMMARY OF THE INVENTION

What is desired then is a game app that is a game of skill that allows a player to win a cash prize for competing against and prevailing over other players that have joined the game where players are presented with questions in a sequential manner.

It is further desired to provide a game app for use on a smartphone that allows a player to join a pool of players where the players simultaneously compete against each other and where a set number of players that answer the most questions correct or complete the most challenges “win” the tier and are selected to move to the next tier to again simultaneously compete against each other.

It is still further desired to provide a system and method for providing a series of questions or challenges to a player where the player only has a limited amount of time to answer each question and the number of questions answered correctly and the time taken to answer each question is used to determine a score where all the players simultaneously compete against each other.

To begin with, all the players that have joined the game will be presented with a limited number of consecutive challenges or questions in the first round and will have a limited time to answer each challenge or question. Once all of the questions have been presented and the time has elapsed the scores for all players will be calculated and a select number of players that have the highest scores, e.g., those with the most correct answers and took the least amount of time in doing so, will be selected to advance to the next round.

Once the next round ends, the top players from that round will advance to the next round. There can be a set number of rounds for the game in which the player with the highest score at the end of the final round is declared the winner. Alternatively, the number of rounds may not be set and will continue until a winner is finally determined. Again, the correct number of answers will be used to determine the winner. Likewise, the time taken to answer each question that was answered correctly will be used to determine the winner. In the case where there is more than one correct answer, the time in answering the questions will become a very important factor.

It is contemplated that each player will be given their score at the end of each round with the top players selected to continue being identified along with their scores. Once the game ends all the players will be given their score and time and also the scores and times for the top players that will advance to the final round.

In the final round, it is contemplated that the top players that have been selected to play in the final round will each be given one question to answer and be given a time frame within which to answer it. The winner is determined by determining if the question was answered correctly and then determining which player answered the question correctly in the shortest amount of time.

In the event that none of the players in the final round answered the question correctly, the same question will then be resubmitted in a random sequence to each player until one of the players answers the question correctly. The random sequence will be generated based on predetermined functionality built in the system.

The winner will get a set percentage of the total cash collected per game however there'll be consideration of a minimum amount that will be paid out. The other players in the final round will at least each win a free game. Once there's a winner, all players from this game will be notified it ended and a new game will start. The process then starts over and players will be invited to participate in the new game.

For this application the following terms and definitions shall apply:

The term “data” as used herein means any indicia, signals, marks, symbols, domains, symbol sets, representations, and any other physical form or forms representing information, whether permanent or temporary, whether visible, audible, acoustic, electric, magnetic, electromagnetic or otherwise manifested. The term “data” as used to represent predetermined information in one physical form shall be deemed to encompass any and all representations of the same predetermined information in a different physical form or forms.

The term “network” as used herein includes both networks and internetworks of all kinds, including the Internet, and is not limited to any particular network or inter-network.

The terms “first” and “second” are used to distinguish one element, set, data, object or thing from another, and are not used to designate relative position or arrangement in time.

The terms “coupled”, “coupled to”, “coupled with”, “connected”, “connected to”, and “connected with” as used herein each mean a relationship between or among two or more devices, apparatus, files, programs, applications, media, components, networks, systems, subsystems, and/or means, constituting any one or more of (a) a connection, whether direct or through one or more other devices, apparatus, files, programs, applications, media, components, networks, systems, subsystems, or means, (b) a communications relationship, whether direct or through one or more other devices, apparatus, files, programs, applications, media, components, networks, systems, subsystems, or means, and/or (c) a functional relationship in which the operation of any one or more devices, apparatus, files, programs, applications, media, components, networks, systems, subsystems, or means depends, in whole or in part, on the operation of any one or more others thereof.

The terms “process” and “processing” as used herein each mean an action or a series of actions including, for example, but not limited to, the continuous or non-continuous, synchronous or asynchronous, routing of data, modification of data, formatting and/or conversion of data, tagging or annotation of data, measurement, comparison and/or review of data, and may or may not comprise a program.

In one embodiment a method of operating an on-line gaming system that a player accesses with a mobile device is provided, the method comprising the steps of receiving a fee from each of a plurality of players to play a game that comprises a plurality of game rounds and determining an amount to be paid to a winner of the game, the amount to be paid based on the total fees received from the plurality of players in the game. The method further includes the steps of simultaneously presenting a series of questions to each of the plurality of players, each of the plurality of players having an opportunity to submit an answer via their mobile device to each of the questions presented and determining a score for each of the plurality of players, the individual scores based on the number of correct answers submitted, and the length of time taken to submit each correct answer. The method still further comprises the steps of selecting first round winners from the plurality of players, the first round winners determined by the highest scores for each of the plurality of players, wherein the number of first round winners is less than the plurality of players and simultaneously presenting a final round question to the first round winners, each of the first round winners having an opportunity to submit an answer to the final round question presented. The method also includes the step of determining a score for each of the first round winners, the individual scores based on whether a correct answer was submitted, and the length of time taken to submit the correct answer. Finally, the method includes the steps of selecting a final winner from the first round winners, the final winner determined by the highest score for the first round winners, and transferring the amount to be paid to the final winner.

In another embodiment a method of operating an on-line gaming system that a player accesses with a mobile device is provided as described in the previous paragraph however, rather than moving from the first round winners directly to the final round, a second round is commenced comprising the following steps, simultaneously presenting a series of questions to each of the first round winners, each of the first round winners having an opportunity to submit an answer via their mobile device to each of the questions presented and determining a score for each of the first round winners, the individual scores based on the number of correct answers submitted, and the length of time taken to submit each correct answer. The method then proceeds to the final round with the second round winners.

In still another embodiment a non-transitory computer-usable storage medium having a program comprising computer readable instructions stored thereon that can be implemented to perform the steps of the method(s) described above when the program is run on a computer, a digital signal processor, a field-programmable gate array, an application-specific integrated circuit, a micro-processor, a micro-controller, or any other form of programmable hardware.

Other objects of the invention and its particular features and advantages will become more apparent from consideration of the following drawings and accompanying detailed description.

### BRIEF DESCRIPTION OF THE DRAWINGS

FIG. 1 is a block diagram of the system according to an aspect of the invention.

FIG. 2 is a block diagram of the system according to FIG. 1.

FIG. 3 is a flow diagram according to FIG. 1.

FIG. 4 is a flow diagram according to FIG. 3.

FIG. 5 is a flow diagram according to FIG. 3.

FIG. 6 is a flow diagram according to FIG. 1.

### DETAILED DESCRIPTION OF THE INVENTION

Referring now to the drawings, wherein like reference numerals designate corresponding structure throughout the views.

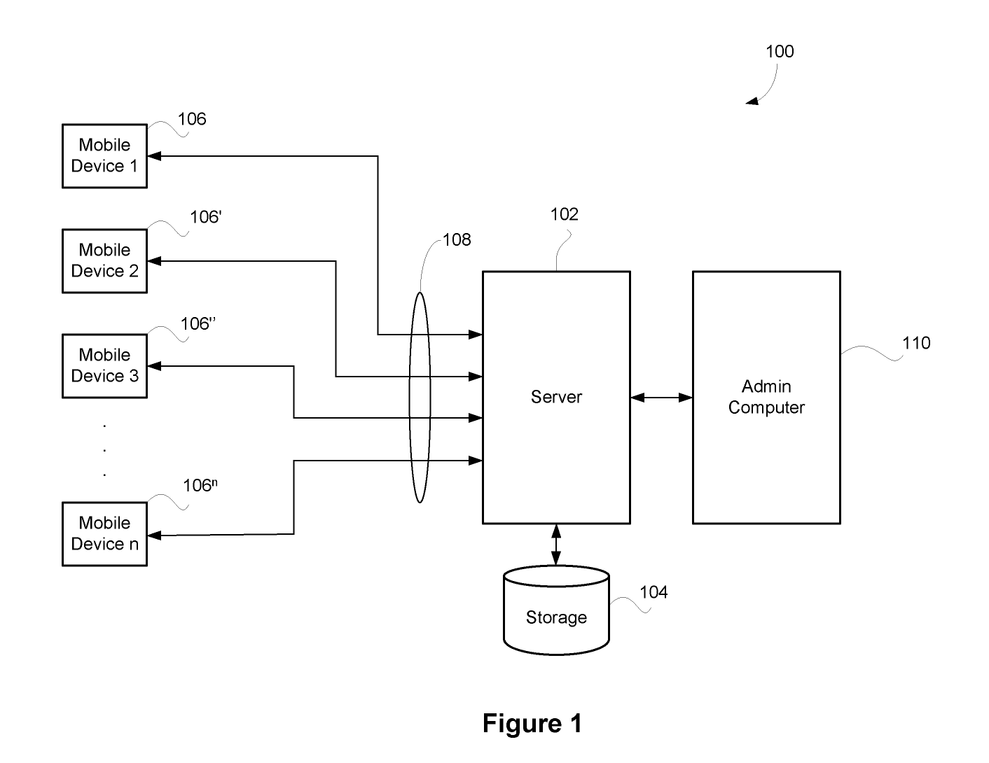

FIG. 1 is a block diagram depicting system 100 including a server 102 that is coupled to a storage 104. Storage 104 may comprise any type of storage that includes, for example, memory accessible by server 102. The storage 104 may be internal to or external to server 102 and could encompass, but is not limited to, RAM, ROM, a magnetic disk and/or drive, a removable hard drive, solid state memory, an optical drive, and so on. Also shown in FIG. 1 are various mobile devices 106, 106′, 106″, 106ⁿ. The mobile devices 106, 106′, 106″, 106ⁿ are coupled to server 102 via a communication network 108, which may comprise any type of network known for connecting a mobile device to a server. The mobile devices 106, 106′, 106″, 106ⁿ may comprise any type of device that is capable of accessing the software on the server 102.

Still further an administration computer 110 is shown connected to server 102. The administration computer 110 may comprise virtually any type of computer that is able to access the server 102 to provide access to the software executing on server 102.

In one advantageous embodiment of the system 100, a game is provided that executes via software that may reside on server 102 and is stored in storage 104. A player is able to access the game via their mobile device 106, 106′, 106″, 106ⁿ to play the game running on the server 102. It is understood that the game may further be played by the user downloading software to their mobile device 106, 106′, 106″, 106ⁿ and accessing the server 102 to receive, for example, data necessary for the game to execute. However, for ease of discussion, the system 100 will be discussed with the software for the game executing on the server 102 that is accessed by the mobile devices 106, 106′, 106″, 106ⁿ.

A player may access the game on the server 102 via a webpage and register an account, which would typically include setting up a user name and a password. Additional data would be input including financial data so that a payment can be made when the player wants to start a game, and if the player wins the game, the system will have information as to where and how to route the players winnings.

In one embodiment, the player will have a limited time frame in which to answer a question or solve a challenge. This time frame may comprise virtually any time frame, but in an advantageous embodiment will comprise ten (10) seconds. It is contemplated that all the players that join a particular game, will be simultaneously presented with the question and will have the same time limit in which to answer the question. If the player answers the question wrong, the player is allocated zero points. If the player answers the question correctly, the time taken to correctly answer the question will be noted for allocation of a point value. In other words, answering the question correctly and submitted in 5 seconds will be scored higher than answering a question correctly and submitted in 8 seconds.

It is contemplated that all the players will be simultaneously presented with a series of multiple questions during the first round of questions. In one embodiment, the first round of questions comprises ten (10) questions. Once all the questions for the first round have been completed, the system 100 will calculate the first round winners, which comprise the players that receive the top ten (10) scores. It should be noted that virtually any number of players may be included as the “winners” of round one and the number 10 is simply selected for discussion. The scores are determined by the total number of correct answers submitted and the time taken to submit each correct answer. It should be noted that the system will track the time taken to submit an answer to a question down to fractions of a second.

In one exemplary embodiment, once the game ends, all the players in that game will be presented with their individual scores. The individuals players may be presented with the number of correct answers, which answers were the correct answers and the time taken for submit the correct answer. Likewise, each player can be presented with the scores of the first round winners (in the case of ten winners, they would be presented with the top ten scores). The winners of round one can then advance to the final round.

In the final round the first round winners (e.g., top 10 players), are each simultaneously presented with one final question (different than the first round questions) and will be given a limited time in which to answer the question (e.g., 10 seconds). The player that answers the question correctly in the shortest time wins.

However, in the case where there is no winner during this stage, then the same question will randomly be presented to each of the players in the final round. The random selection will be based on predetermined functionality built in the system, where the first player to answer the question correctly will win. The winner will get a set percentage of the total cash collected per game, however, it is contemplated that there will be consideration of a minimum amount that will be paid out. The other players in the final round will win a free game. Once there is a winner, all players from the current game will be notified that the game has ended and a new game will prepare to start. The process then starts over and players will be invited to participate in the new game.

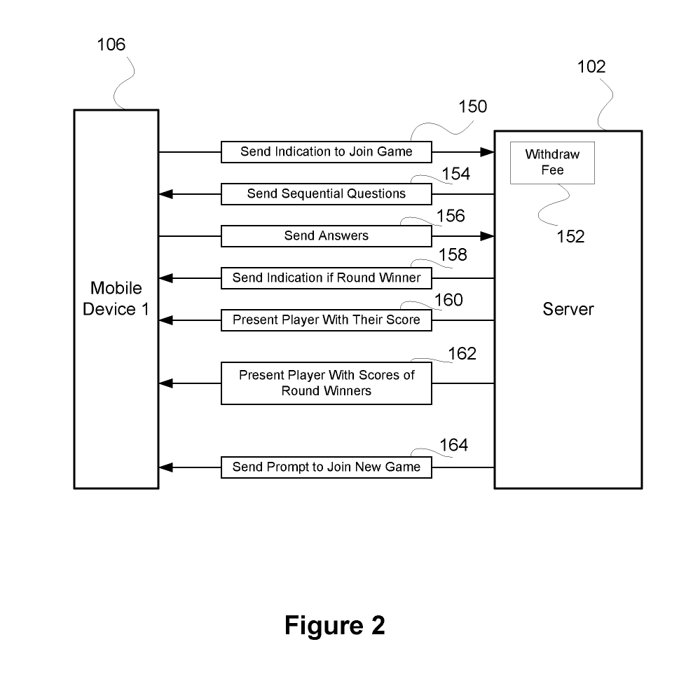

Turning to FIG. 2 a block diagram of mobile device 106 interacting with server 102 is illustrated. As is depicted, mobile device 106 may be used to send an indication to join a game 150. The player will have already set up an account associated with the player and logged in. Upon receipt of the request to join the game 150, the system 100 can then withdraw the fee 152 required to play that particular game. It should be noted that the fee withdrawn will be commensurate with the difficulty of the questions that will be presented in that game. The fee is then withdrawn, and the player may get a notification that the game will start in x number of minutes.

Once the game commences, a series of questions is sent 154 to the mobile device 106. It should be noted that the same question is simultaneously sent to all the players in the game. The player will have a set time in which to answer the question correctly (e.g., 10 seconds). Failure to answer the question in the time frame will result in the system assigning an incorrect answer to the question. The player then, sends in their answers 156 to the questions.

Once all the questions for the first round are sent and all the answers are determined, the system 100 then will determine the first round winners and will send an indication if the player is a first round winner 158. The system will also present the player's score 160 and will present the score of the first rounds winners 162 to the player. If the player is one of the first round winners, the player will have the opportunity to compete in the final round. If the player is not one of the first round winners, the player will have to wait for the game to finish. Once a final round winner is determined, the system will send a prompt to the player asking if they would like to join a new game 164.

It is contemplated that prior to the start if each game, players will get notifications to join before the start of the game. Likewise, there could be a number of games that are scheduled to start and the player can decide which of the games to join. The notification period may open for a set time period (e.g., up to 10 minutes after the minimum number of paying players have signed up). During this this period additional players may join the game and a countdown to the start of the game will be provided. Once the game commences, no further players will be allowed to join the current game.

It is contemplated that the various game may be provided on a continual basis, 24 hours a day, 7 days a week.

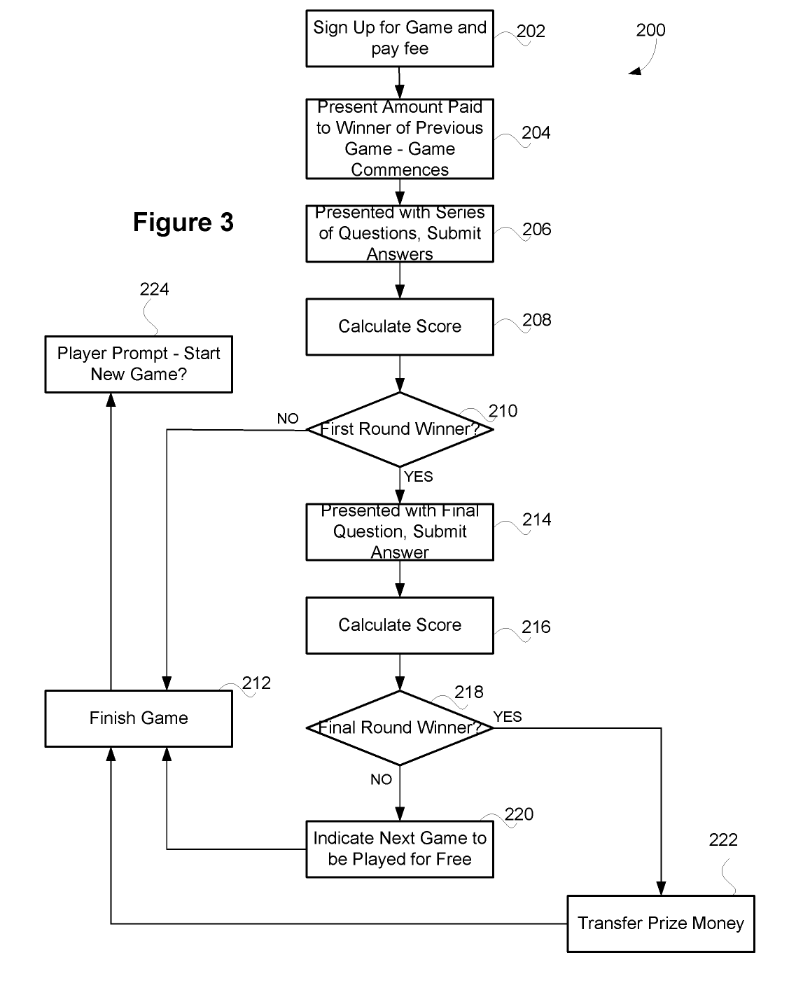

FIG. 3 is flow diagram 200 depicting the functioning of the system 100. Initially, a player will sign up for a game pay the fee 202. The system may present the amount paid out to the winner of the previous game 204 to various players incentivizing them to join the current game. Once all the players have joined the game, the game commences.

It should be noted that alternatively, the once all the players have joined the current game, the system may then calculate an amount to be paid out to the final winner (based on the number of players in the current game) and can present that amount to all the players of the current game even before the current game commences. Alternatively, the system could provide a running calculation of the amount to be paid for the current game and provide that amount to some or all the players (even those that have not joined the current game) to incentivize them to join before the game commences.

Once the game commences, the players are simultaneously presented with a series of questions 206, to which each player has the opportunity to submit an answer within a time frame.

At the end of the first round, the system will calculate the players score 208. The system then determines if the player is a first round winner 210. If the player is not a first round winner, the game ends 212 and the player will have to wait for a new game to start. If the player is determined to be a first round winner, the player is presented with a final round question 214.

The system will then determine the player's score for the final round 216. Based on the scores for all the players competing in the final round, the system will then determine if the player is the winner of the final round 218. If the player is not the winner of the final round, the system will indicate that the next game the player joins will be free 220 (which is noted in the players account) and the game ends 212. If the player is the winner of the final round, the system will transfer the prize money 222 to the players account and then the game will end 212.

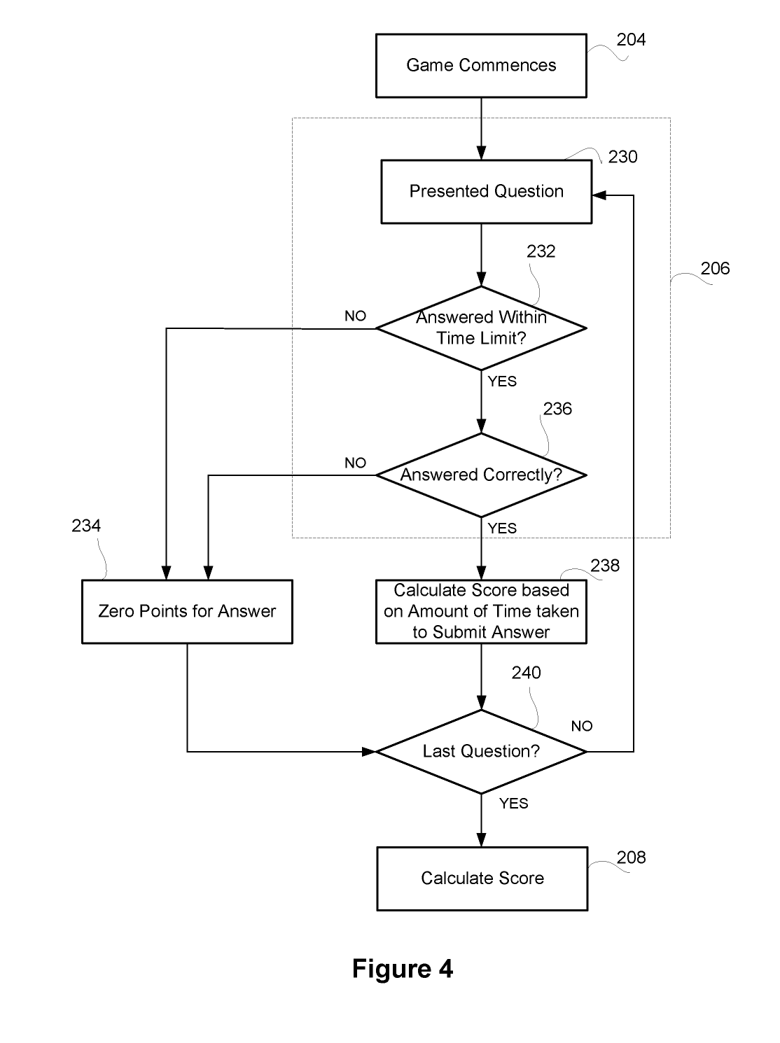

FIG. 4 shows step 206 of FIG. 3 in greater detail. Once the game commences 204 the player is presented with a question 230. The player then has an opportunity to submit an answer. The system will then determine if the answer was submitted within the time limit 232. If no, the system will assign zero points 234 for the untimely answer. If yes, the system will then determine if the answer is correct 236. If no, the system will assign zero points 234 for the incorrect answer. If yes, the system will then calculate a score based on the time taken to submit the correct answer 238.

If either the answer was untimely or incorrect, the system will advance from assigning zero points to the step of determining if the last question in the round has been resolved 240. Likewise, if the answer is timely and correct, once the score is calculated 238, the system then determines if the last question in the round has been resolved 240. If not, the system moves back to step 230 and presents the next question and the process is repeated. If yes, the system proceeds to calculating an overall score 208 for the player.

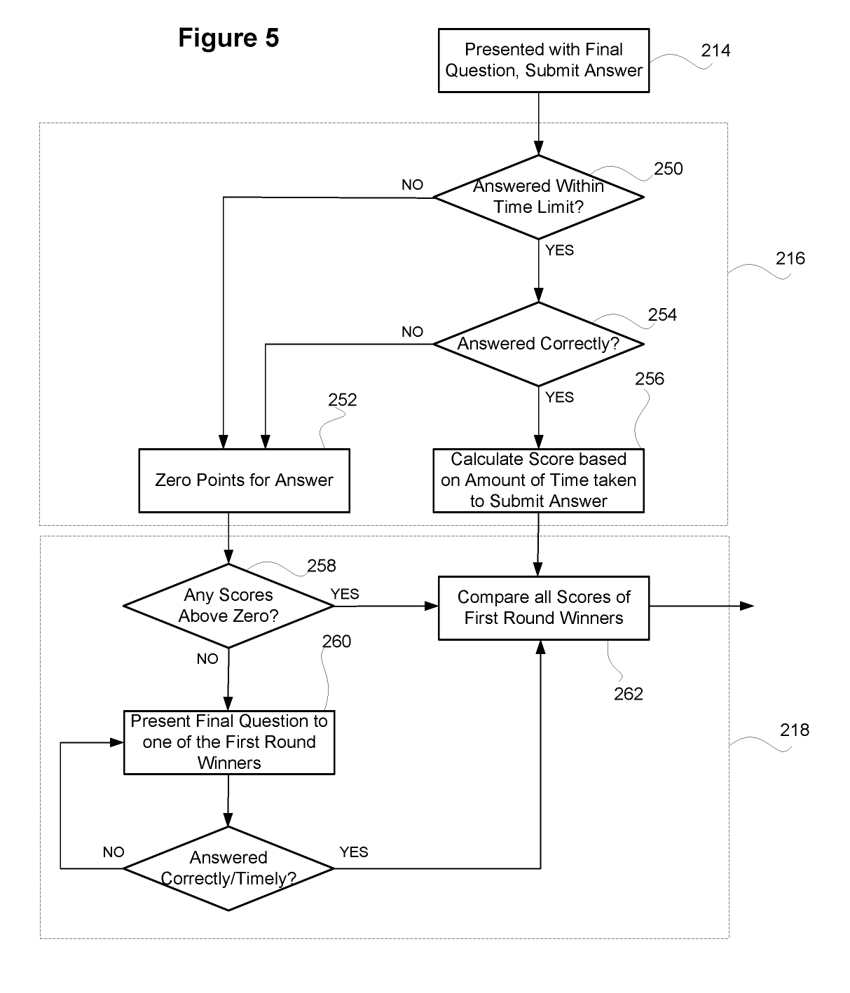

FIG. 5 is a flow diagram that shows steps 216, 218 of FIG. 3 in greater detail. Once the player is presented with a final question 214 and submits an answer, the system then determines if the answer was submitted timely 250. If no, the system then assigns zero points 252 for the untimely answer. If yes, the system then determines if the answer is correct 254. If no, the system then assigns zero points 252 for the incorrect answer. If yes, system then determines a score based on the time taken to submit the answer 256.

If the answer is untimely submitted or incorrect, the system then proceeds to determine if any score submitted by any player in the final round is above zero 258. If no player has a score above zero, then the system will randomly select and present the final question to one of the players allowing that player a limited time frame to answer the question 260. If the player answers the question correctly and within the time frame, the system will proceed to comparing all the scores of the first round winners 262. If the player that was presented the final question 260 does not answer within the time frame or submits an incorrect answer, the system will then randomly select another of the first round winners to present the final question to. That next player will then have an opportunity to answer the question correctly within the time frame. If the player does not answer the question correctly or within the time frame, the system will continue to randomly cycle through the remaining players until a correct answer is received within the allotted time frame. If all the remaining players fail to submit a timely or correct answer, the system will then reset and begin the random selection process and presentation of the question again.

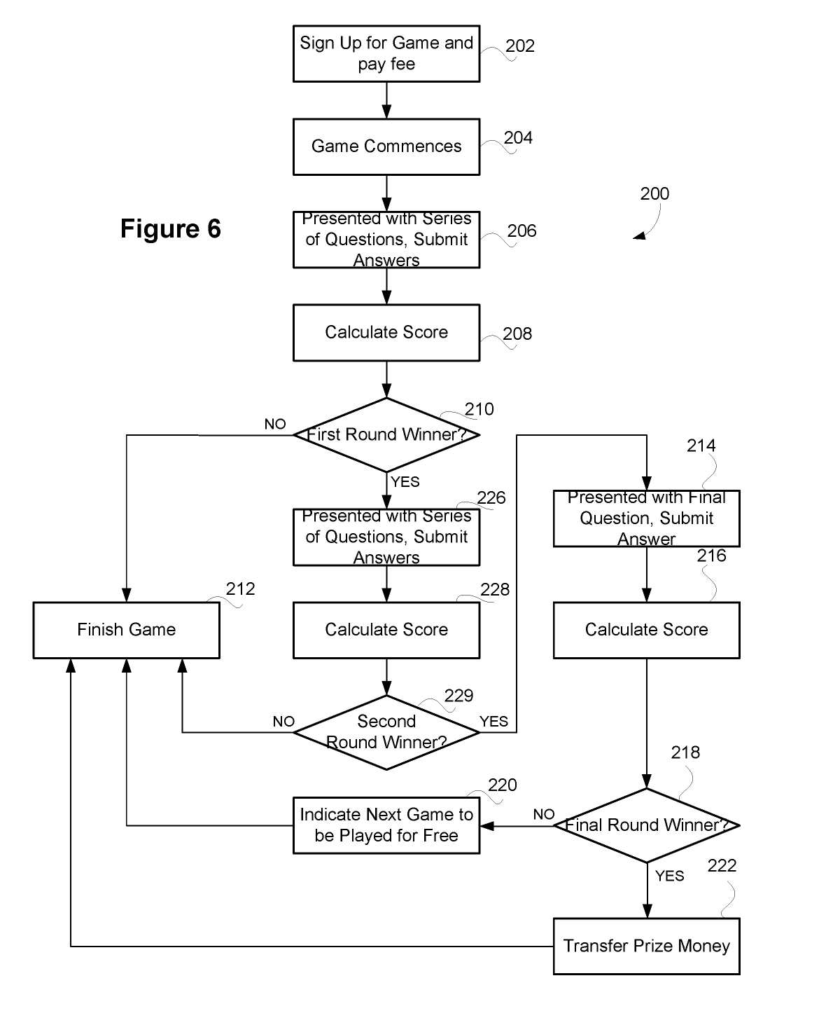

Turning now to FIG. 6, a flow diagram is provided that is similar to that illustrated in FIG. 3 with the exception that there is an intervening round between the first round and the final round.

Since the method of FIG. 6 is substantially similar with that described in connection with FIG. 3, the repeated steps will not be re-described here. The additional steps of FIG. 6 include, if the player is determined to be a first round winner 210, the system then proceeds with presenting another series of questions 226 with the player having an opportunity to submits answers in a similar fashion as described in connection with FIGS. 3 and 4 for the first round questions.

The system then calculates a score for the players in the second round 228 and then determines if the player is a second round winner 229. If the player is not a second round winner, the system then finishes the game 212 for the player. If the player is a second round winner, the system then moves to the final round, which proceeds in the same manner as described in connection with FIGS. 3 and 5.

While FIG. 6 describes the a first rounds of multiple questions, a second round of multiple questions and then a final round question, it should be understood that any number of questions can be presented in virtually any number of rounds.

It will be appreciated that there may be “bonus” games where the winning player's payout will be doubled for the bonus game. Once the number of bonus games per day is determined, the system will automatically pick which game(s) is selected.

In addition, in another aspect to the game there will be an “enter the 10 zone” where players who have more time on their hands will be allowed to go in this game zone and answer a number of questions within a certain timeframe to try to win the prize. Players will get notifications to sign up for the game from 30 minutes before the start. Once the 30-minute notification period ends players will no longer be allowed to sign up for the game and the game will commence. There will also be a countdown from 30 mins to the start of the game. It is contemplated that there may be four of these types of games per day, which may be commence at 9:00 am, 1 pm, 7 pm and 1 am (EST) each day and last for 10 mins. While all times are Eastern time zone, they will need to be translated in the different time zones. Players will in these games will get 60 questions and the player with the highest number of right answers and quickest time in answering the questions will win Again, speed of answering will need to be tracked and used as a tie breaker, if applicable, in this game. At the end of the game each player in the game will be notified it has ended and what their score and time was along with the winning player's score and time. In this type of game, there may be three payouts. The winner of this game will get the main prize of the set percentage of the game and then there'll be a second prize payout (e.g., $500) for the next best score and a third prize payout (e.g., $250) of the third best score. Questions will all be on world topics of a general nature but will have a few regional/local questions. A higher fee will be charged with a higher expected payout.

It is still further contemplated that different types of games may be available for the players such that, players can only enter games with questions from subjects they're interested in. There also may be a weighting system for questions so depending on difficulty a question, the amount of money required to be paid and the corresponding payout will vary.

A player will be able to download the game app from an App store for free. The game may be provided in multiple languages. Once downloaded, the player will need to set up a unique player account (username, password, password challenge questions, agree to privacy policy and terms and conditions etc.). IT should be noted that the system will reject any duplicate username. A player can only play the game after all the requirements for the unique account have been met. In addition, in order to play the game, a player will be required to pay the game fee (e.g., $2.99 per game). The player will then be routed to a secure screen where they'll have the ability to pay the game fee by various payment methods (credit card, PayPal, bank account transfer, etc.). Once the fee is paid, the player's account will be automatically entered in the current game. If the current game has already started they'll automatically be entered in the next game. The player will get a confirmation that they've been entered into a game. When the player gets each challenge or question, there'll be a notification on their screen and a timer starts that will count down from a preselected time (e.g., 10 seconds). The question may include all types of subject matter. It also could be a challenge for the player to figure out how to unlock something based on predetermined criteria. Once a player wins a game, all the players that were included in that game will be notified automatically with a message indicating that their game ended and there was a winner. Each player will then be prompted if they would like to enter the new game. In addition, a prompt will go out at a specific time each day to all players about entering games.

A challenge or question will be randomly generated from the system, which may have been obtained from a wide array of sources. The predetermined answer will also be built in with a code that once the answer is submitted it will end the game (based on the above description of the game with different rounds). Batches of questions with their corresponding answers will be uploaded and stored in a secure area on the server/storage. The system will then automatically send out the questions in a sequence. A list of all questions will be stored in this secured area and questions will not be allowed to be repeated, so if an attempt is made to upload a question that have already been used, the system will reject the repeated question. Alternatively, algorithms will be built that can develop questions and answers (multiple choice) which will then be sent out automatically by the system (this may be facilitated by internet listening capabilities). Also, built in the system will be the fact that each player will only be given a limited time (10 seconds) to answer. All challenges or questions will be vetted prior to being included in production to ensure the question/challenge can indeed be answered within the allotted timeframe. Only one account will be allowed per player at any one time. A player will be allowed, for any reason, to delete one account and create a new account. At the inception of the game, a game will not be allowed to commence and question sent to players until the minimum number of players have signed up for a game in order to meet the minimum payout threshold.

Logics/codes will be built into the system that will allow the various ways of winning:

Once a player wins, this player account will be flagged and instructions on how to collect winnings will automatically be routed to the player's screen. US winners will also be required to provide their mailing address and Tax ID or Social Security number if winnings is above $600 before they can collect their winnings so the company can issue a 1099-MISC Other Income form to them for tax purposes.

Certain games per day will be randomly selected as the bonus game. However, this will not be known to anyone as the system will randomly select it. Only when the player answers the question correctly will it be identified as the bonus game and the expected bonus payout determined.

A player will be able to win 25% of all the cash entered for each game by players. In addition, during bonus games this amount will be doubled. This means the winnings can be substantial depending on the number of players participating per game. The winnings from the previous game will be highlighted at the start of each game. Also, past winnings and testimonials will be highlighted on the home page of app/website. In addition, there may be a loyalty program where players can win free games.

Future variants of the game may also attribute different difficulty levels to questions and factor this variable into players' scores (i.e. players who correctly answer difficult questions will be awarded more points). Players may also be allowed to enter and play games in which questions will be restricted to subjects they are interested in.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A method of operating an on-line gaming system that a player accesses with a mobile device, the method comprising the steps of:
a) receiving a fee from each of a plurality of players to play a game that comprises a plurality of game rounds;
b) determining an amount to be paid to a winner of the game, the amount to be paid based on the total fees received from the plurality of players in the game;
c) simultaneously presenting a series of questions to each of the plurality of players, each of the plurality of players having an opportunity to submit an answer via their mobile device to each of the questions presented;
d) determining a score for each of the plurality of players, the individual scores based on:
1) the number of correct answers submitted; and
2) the length of time taken to submit each correct answer;
e) selecting first round winners from the plurality of players, the first round winners determined by the highest scores for each of the plurality of players, wherein the number of first round winners is less than the plurality of players;
f) simultaneously presenting a final round question to the first round winners, each of the first round winners having an opportunity to submit an answer to the final round question presented;
g) determining a score for each of the first round winners, the individual scores based on:
1) whether a correct answer was submitted; and
2) the length of time taken to submit the correct answer;
h) selecting a final winner from the first round winners, the final winner determined by the highest score for the first round winners; and
i) transferring the amount to be paid to the final winner.

2. The method of operating an on-line gaming system according to claim 1 wherein the method further comprises the following additional steps occurring after step e) and before step f):
e1) repeating steps c) and d) for the for the first round winners; and
e2) selecting second round winners from the first round winners, the second round winners determined by the highest scores determined for each of the first round winners, wherein the number of second round winners is less than the number of first round winners;
wherein steps f) and g) are performed with respect to the second round winners.

3. The method of operating an on-line gaming system according to claim 1 wherein the step of simultaneously presenting a series of questions to each of the plurality of players further includes establishing a time limit in which to answer the question, wherein if the question is not answered within the time limit, the question is considered to be answered incorrectly.

4. The method of operating an on-line gaming system according to claim 1 wherein if no player answers the final round question correctly, an auxiliary round will commence where the final round question is randomly presented to one of the first round winners for a predefined period of time in which the player has an opportunity to answer the question within the predefined time.

5. The method of operating an on-line gaming system according to claim 4 wherein if the final round question is not answered correctly by the randomly selected one of the first round winners, the final round question is randomly presented to a second one of the first round winners giving that player an opportunity to answer the question within the predefined time.

6. The method of operating an on-line gaming system according to claim 5 wherein the system continues to randomly present the final round question to the first round winners in a sequential manner until the final round question is answered correctly.

7. The method of operating an on-line gaming system according to claim 1 wherein the amount to be paid is selected to be the greater of a percentage of all the fees received or a predefined amount.

8. The method of operating an on-line gaming system according to claim 1 wherein at the end of game each player will be prompted if they would like to enter the new game.

9. The method of operating an on-line gaming system according to claim 1 wherein a prompt will be sent to a plurality of players at a preselected time regarding entering games.

10. The method of operating an on-line gaming system according to claim 1 wherein a game is randomly selected to be a bonus game that applies a multiplier to the amount to be paid to the final winner.

11. The method of operating an on-line gaming system according to claim 1 wherein once the scores for each of the plurality of players is determined, individual players will be presented with their score.

12. The method of operating an on-line gaming system according to claim 11 wherein each of the plurality of players will be presented with the number of correct answers they submitted and the time taken for each correct answer.

13. The method of operating an on-line gaming system according to claim 11 wherein each of the plurality of players will be presented with the scores for the first round winners.

14. The method of operating an on-line gaming system according to claim 13 wherein each of the plurality of players will be presented with the number of correct answers and the time taken for each correct answer submitted by the first round winners.

15. The method of operating an on-line gaming system according to claim 1 wherein each question is weighted based on difficulty such that the difficulty of the question is taken into consideration in determining the a players score.

16. The method of operating an on-line gaming system according to claim 1 wherein each question is weighted based on difficulty such that the difficulty of the questions are taken into consideration in determining the fee to be paid to enter the game.

17. The method of operating an on-line gaming system according to claim 1 wherein the amount to paid to the final winner from the previous game is highlighted at the start of each new game.

18. A non-transitory computer-usable storage medium having a program comprising computer readable instructions stored thereon that can be implemented to perform the steps of the method according to claim 1 when said program is run on a computer, a digital signal processor, a field-programmable gate array, an application-specific integrated circuit, a micro-processor, a micro-controller, or any other form of programmable hardware.
